(19) United States
(12) Patent Application Publication
(10) Pub. No.: US 2023/0385755 A1
(43) Pub. Date: Nov. 30, 2023

(54) METHODS, SYSTEMS, ARTICLES OF MANUFACTURE AND APPARATUS TO REGRESS INDEPENDENT AND DEPENDENT VARIABLE DATA

(71) Applicant: Nielsen Consumer LLC, Chicago, IL (US)

(72) Inventors: Christiana Spyrou, Nicosia (CY); Azam Pirmoradian, Oxford (GB); Ognyan Vassilev, Sofia (BG); Pawel Mikolaj Bedynski, Strzeniowka (PL); Anastasiya Chilingirova, Sofia (BG)

(21) Appl. No.: 17/976,519

(22) Filed: Oct. 28, 2022

Related U.S. Application Data
(60) Provisional application No. 63/346,211, filed on May 26, 2022.

(51) Int. Cl. G06Q 10/08; G06Q 30/02

(52) U.S. Cl. CPC G06Q 10/087; G06Q 30/0202

(57) ABSTRACT

Methods, apparatus, systems, and articles of manufacture are disclosed to regress independent and dependent variable data. An example apparatus to generate movement values for a regression model includes at least one memory, machine readable instructions, and processor circuitry to at least one of instantiate or execute the machine readable instructions to calculate period average sales values for ones of stores associated with (a) a store group of interest, (b) a category of interest and (c) ones of periods of interest, the period average sales values based on a number of the ones of the stores. The example processor circuitry also at least one of instantiates or executes the machine readable instructions to calculate period average stock values for the ones of the stores associated with (a) the store group of interest, (b) the category of interest and (c) the ones of the periods of interest, the period average stock values based on the number of ones of the stores, calculate overall average sales values based on the period average sales values corresponding to all of the ones of the periods of interest, calculate overall average stock values based on the period average stock values corresponding to all of the ones of the periods of interest, and prevent random effects corresponding to stock input data used in the regression model by calculating sales movement values based on a difference between the period average sales values and the overall sales values, and calculating stock movement values based on a difference between the period average stock values and the overall average stock values.

### RELATED APPLICATION

This patent claims the benefit of U.S. Provisional Patent Application No. 63/346,211, which was filed on May 26, 2022. U.S. Provisional Patent Application No. 63/346,211 is hereby incorporated herein by reference in its entirety. Priority to U.S. Provisional Patent Application No. 63/346,211 is hereby claimed.

### FIELD OF THE DISCLOSURE

This disclosure relates generally to non-correlative effects between independent and dependent variables and, more particularly, to methods, systems, articles of manufacture and apparatus to regress independent and dependent variable data.

### BACKGROUND

In recent years, auditors have visited retail locations to identify stock data corresponding to products of interest. Typically, auditor visits occur on a periodic basis to collect stock information, such as a quantity of particular products that are available to consumers, such as the quantity of products that can be observed on a retail shelf.

### BRIEF DESCRIPTION OF THE DRAWINGS

FIG. 1 illustrates a graphical representation of sales data and stock data for which a regression is attempted in a manner consistent with the teachings of this disclosure.

FIG. 2 is a block diagram of an example environment including regression circuitry constructed in accordance with teachings of this disclosure to determine stock metrics via a regression analysis.

FIG. 3 is a block diagram of the regression circuitry of FIG. 2 to determine stock metrics via a regression analysis.

FIGS. 4-6 are flowcharts representative of example machine readable instructions and/or example operations that may be executed by example processor circuitry to implement the regression circuitry of FIGS. 2 and 3.

FIG. 7 is a block diagram of an example processing platform including processor circuitry structured to execute the example machine readable instructions and/or the example operations of FIGS. 4-6 to implement the regression circuitry of FIGS. 2 and 3.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIGS. 4-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Analyst techniques to determine sales metrics for retail establishments typically enlisted the efforts of auditors to physically visit the retail establishments and record quantities of products of interest available to consumers. Based on stock information data points, other marketing metrics are calculated, such as estimated sales volumes for particular products. However, more recent developments in retail establishments and/or arrangements between retail establishments and analysts include abundant sales information. In some examples, the sales information is obtained from point-of-sale (PoS) systems that scan every product sold at the retail establishment. As such, sales information is no longer derived and/or otherwise estimated based on stock information and, instead, the sales information is granular and accurate.

Because PoS systems provide granular sales information from participating retail establishments, auditor resources are either no longer utilized or utilized infrequently. Accordingly, stock information is no longer available in raw form (e.g., actual stock information observations from auditors that visit the retail establishment). Instead, stock information must be estimated based on sales information and/or retrieved from a limited/reduced number of auditor resources, if any.

Traditional approaches to estimate, calculate and/or otherwise derive stock information in view of limited auditor resources include evaluating relationships between sales data (e.g., sales units of products of interest) and sales ratio information corresponding to retailers deemed similar (e.g., referred to as “sister stores”). In some examples, traditional approaches initially calculate a total stock value in a manner consistent with example Equation 1.

TotalStockᵢⱼ=salesRatioᵢⱼ*ΣsalesUnitsᵢⱼ Equation 1.

In the illustrated example of Equation 1, i represents a store/retailer identifier and j represents a category or product class of interest. Additionally, in the illustrated example of Equation 1, salesRatio represents statistical ratios from one or more sister stores.

The aforementioned traditional approach also calculates a calibration ratio in a manner consistent with example Equation 2.

$${calRatio}_{i j} = \frac{{TotalStock}_{i j}}{\sum \sqrt{s a l e s U n i t {s}_{i j}}} . \qquad Equation 2$$

Additionally, the aforementioned traditional approach calculates a stock level/value by item in a manner consistent with example Equation 3.

stockᵢⱼ=calRatioᵢⱼ\sqrt{salesUnitsᵢⱼ} Equation 3.

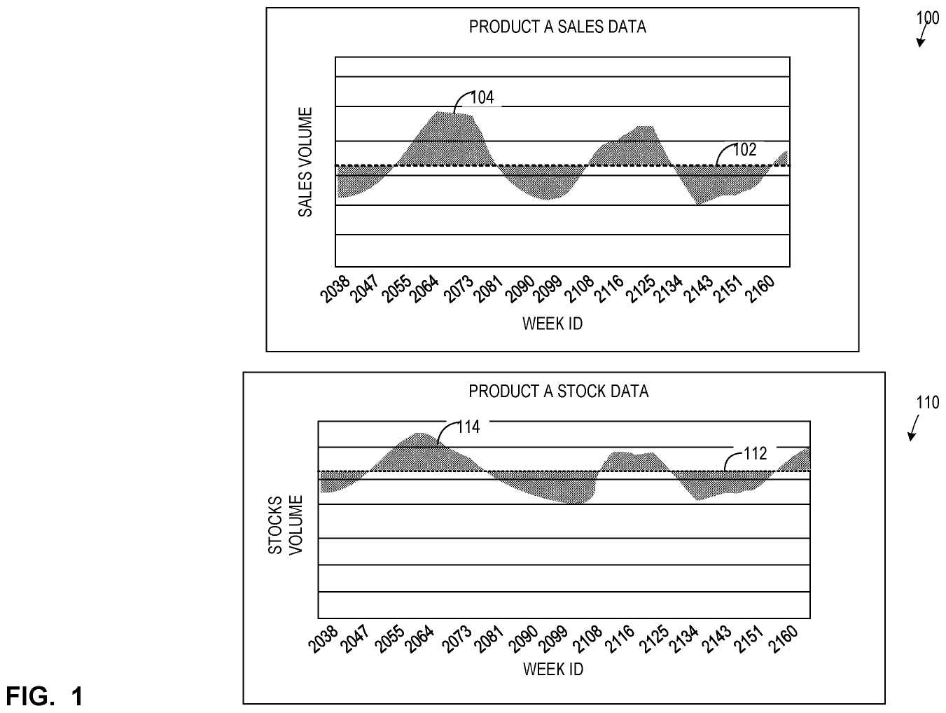

While the traditional approach allows an estimation of stock values, this approach suffers from bias in a manner that fails to satisfy accuracy requirements when compared to ground truth data. Sales data and stock data do not exhibit a linear relationship. However, a graphical analysis of sales data and stock data do exhibit a relationship, as shown in FIG. 1. In the illustrated example of FIG. 1, a first chart 100 includes sales data corresponding to a particular product (“Product A”) in which a sales volume (y-axis) is plotted against a temporal metric (x-axis), such as weeks, days, months, etc. As is evident from the example first chart 100, particular weeks exhibit a particular sales volume (line 104) in view of an overall average sales volume 102. The example overall average sales volume 102 is based on a totality of values throughout the entire temporal period (x-axis).

In the illustrated example of FIG. 1, a second chart 110 includes stocks data corresponding to the same product (“Product A”) in which a stocks volume (y-axis) is plotted against a temporal metric (x-axis), which includes the same metric of time in the example first chart 100. In particular, the temporal metric (x-axis) of the second chart 110 includes data for the same periods of time as shown in the first chart 100. As is evident from the example second chart 110, particular weeks exhibit a particular stocks volume (line 114) in view of an overall average stocks volume 112. The first chart 100 and the second chart 110 illustrate average values per period in view of the overall average values (see average sales 102 and average stocks 112) for a particular category of product (e.g., shampoo). In view of the first chart 100 and the second chart 110, period volumes deviate in a same direction, but may involve different magnitudes.

Despite a visual observation that sales and stock have some sort of relationship, efforts to perform a regression analysis on stock and sales data fails to illustrate a correlation (e.g., in some examples the stock value dependent variable behaves as a random event in view of sales value independent variables). In some examples, when the traditional approach generates an estimation of stock values that do not satisfy a threshold accuracy value when compared to ground truth data, re-modeling efforts are implemented. However, re-modeling efforts consume computational resources, which require additional energy for both (a) the computational resource execution (e.g., server racks, graphical processing units (GPUs), accelerators, etc.) and (b) heat management/evacuation for the computational resources.

Examples disclosed herein estimate stock based on sales data in a manner that satisfies threshold accuracy values, reduces energy consumption by avoiding re-modeling efforts, and eliminates numeric anomalies that cause dependent variables to appear as random events. Unlike merely performing regression efforts on sales and stocks data, examples disclosed herein model and regress movement of the sales and stocks data, which may be seen as the area below and above the example sales volume (see line 104) and the example stocks volume (see line 114). As described in further detail below, determining movement data for the stocks and sales data is achieved by particular types of averaging. Stated differently, examples disclosed herein transform data that exhibits no correlation into a different type/representation of data that exhibits a degree of correlation, which can then be modeled. In particular, examples disclosed herein enable regression analysis (modeling) to proceed in view of analyzing a movement of averages.

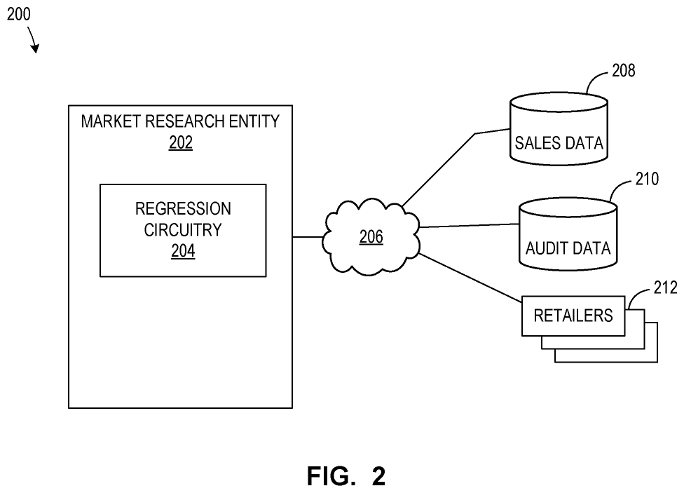

FIG. 2 is a block diagram of an example environment 200 constructed in accordance with teachings of this disclosure for determining stock metrics. The example environment 200 of FIG. 2 includes an example market research entity (MRE) 202, which is an entity that collects and/or analyzes market data to generate actionable insights. In some examples, the MRE 202 of FIG. 2 is implemented by one or more servers, such as a physical processing center, an example cloud or Edge network (e.g., Amazon Web Services® (AWS)). In some examples, the MRE 202 includes a cloud-based architecture that integrates data assets and analytics into a platform.

The example MRE 202 includes example regression circuitry 204, in which the MRE 202 and regression circuitry 204 are communicatively connected to an example network 206. The example network 206 facilitates at least one communication path to any number of data sources, such as an example sales data source 208, an example audit data source 210 and/or example retailer(s) 212 and corresponding data contained therein. While the illustrated example of FIG. 2 includes the example sales data source 208 and the example audit data source 210 as external to the example MRE 202, in some examples such data sources may reside within the MRE 202.

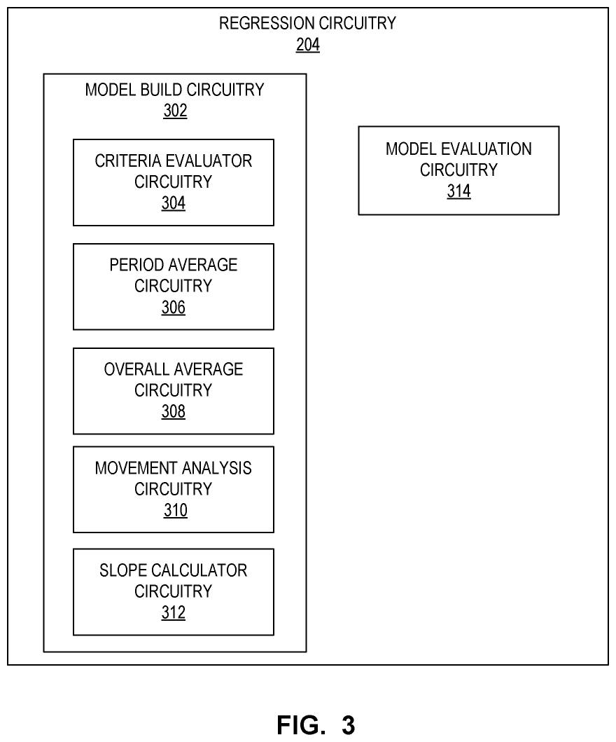

FIG. 3 is a block diagram of the regression circuitry 204 of FIG. 2 to regress independent and dependent variable data (e.g., sales and stock data, respectively) that, in a first form, exhibits non-correlative effects. The example regression circuitry 204 of FIGS. 2 and 3 may be instantiated (e.g., creating an instance of, bring into being for any length of time, materialize, implement, etc.) by processor circuitry such as a central processing unit executing instructions. Additionally or alternatively, the example regression circuitry 204 of FIGS. 2 and 3 may be instantiated (e.g., creating an instance of, bring into being for any length of time, materialize, implement, etc.) by an ASIC or an FPGA structured to perform operations corresponding to the instructions. It should be understood that some or all of the circuitry of FIGS. 2 and 3 may, thus, be instantiated at the same or different times. Some or all of the circuitry may be instantiated, for example, in one or more threads executing concurrently on hardware and/or in series on hardware. Moreover, in some examples, some or all of the circuitry of FIGS. 2 and 3 may be implemented by microprocessor circuitry executing instructions to implement one or more virtual machines and/or containers.

Further to the above, FIG. 3 illustrates additional detail corresponding to the example regression circuitry 204 of FIG. 2. In the illustrated example of FIG. 3, the regression circuitry 204 includes example model build circuitry 302 and example model evaluation circuitry 314. The example model build circuitry 302 includes example criteria evaluator circuitry 304, example period average circuitry 306, example overall average circuitry 308, example movement analysis circuitry 310, and example slope calculator circuitry 312. In some examples, the aforementioned circuitry of FIG. 3 is instantiated by processor circuitry executing model build instructions, model evaluation instructions, criteria evaluation instructions, period average instructions, overall average instructions, movement analysis instructions and slope calculation instructions and/or configured to perform operations such as those represented by the flowcharts disclosed herein.

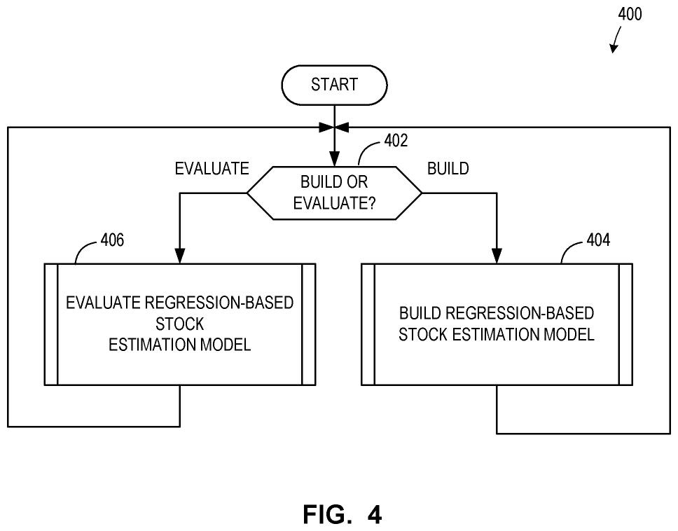

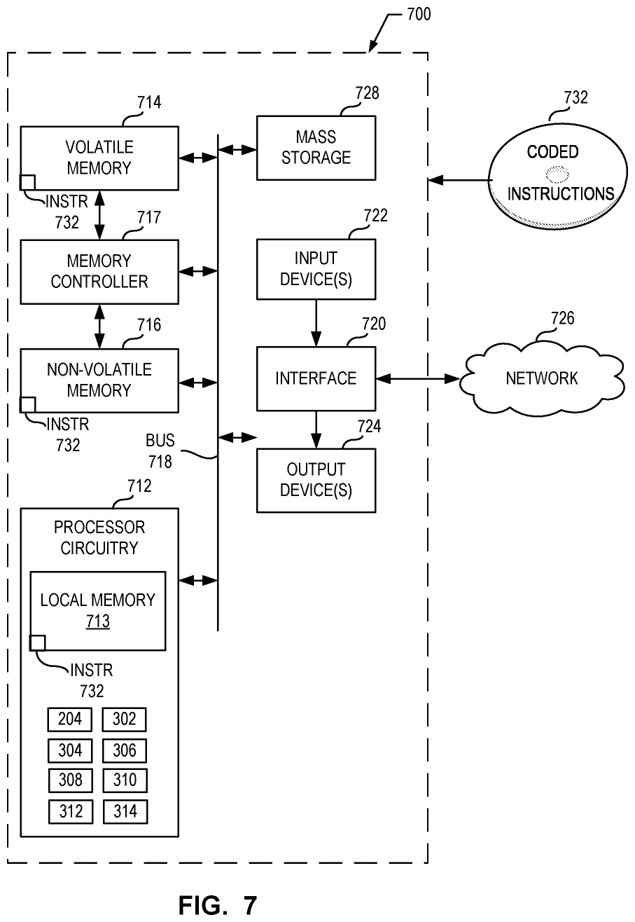

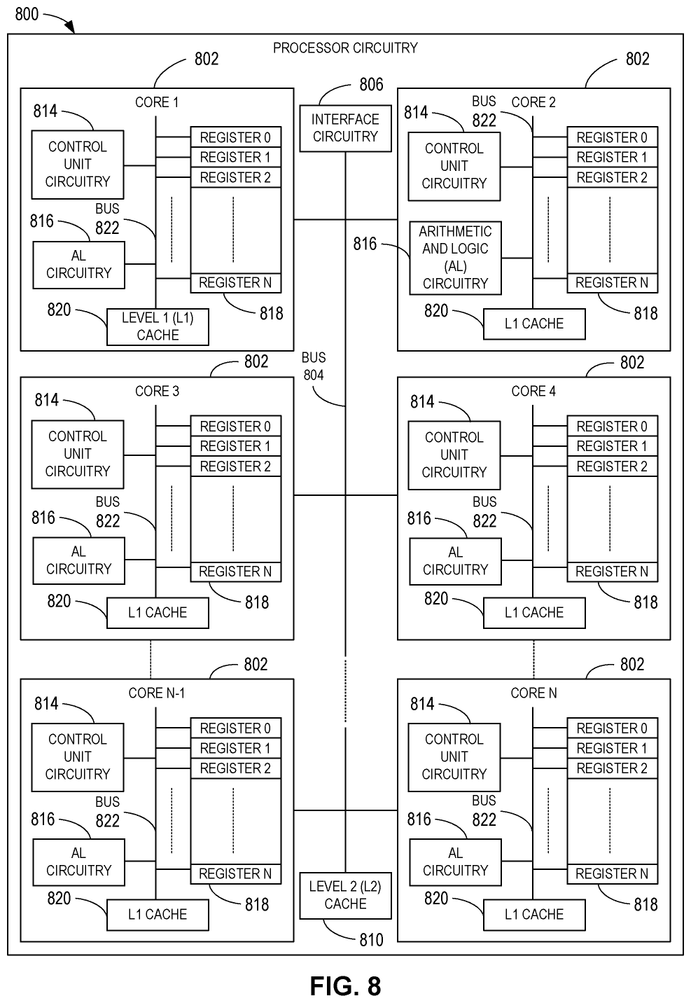

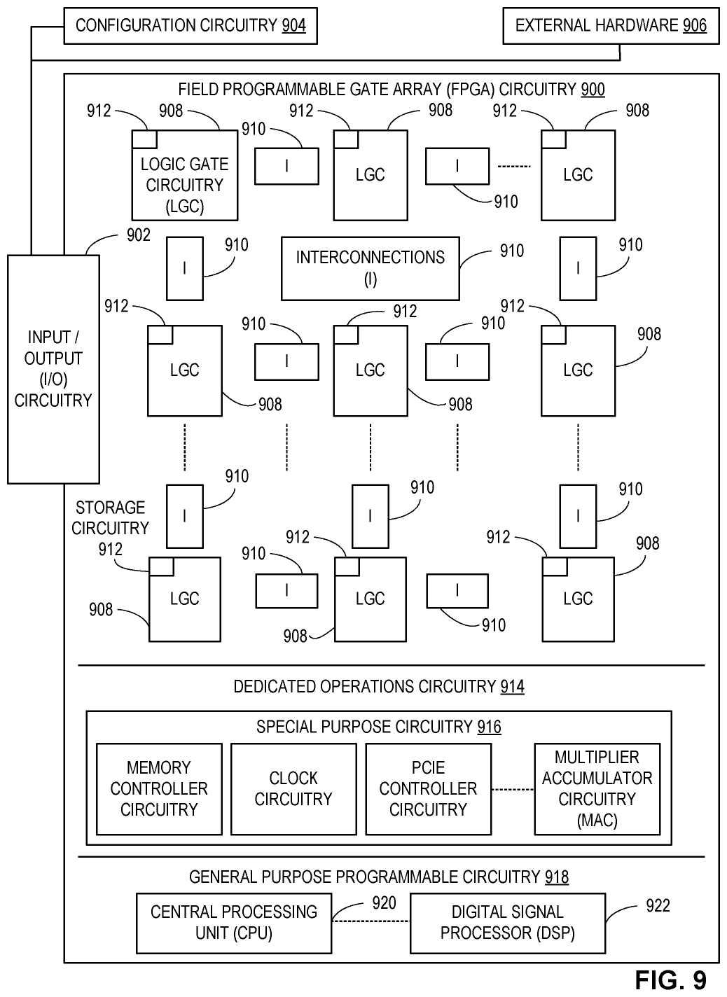

In some examples, the regression circuitry 204 includes means for regression, the model build circuitry 302 includes means for model construction, the model evaluation circuitry 314 includes means for model evaluation, the criteria evaluator circuitry 304 includes means for criteria evaluation, the period average circuitry 306 includes means for period average determination, the overall average circuitry 308 includes means for overall average determination, the movement analysis circuitry 310 includes means for movement analysis, and the slope calculator circuitry 312 includes means for slope calculation. For example, the aforementioned means may be implemented by, respectively, the regression circuitry 204, the model build circuitry 302, the model evaluation circuitry 314, the criteria evaluator circuitry 304, the period average circuitry 306, the overall average circuitry 308, the movement analysis circuitry, and the slope calculator circuitry 312. In some examples, the aforementioned circuitry may be instantiated by processor circuitry such as the example processor circuitry 712 of FIG. 7. For instance, the aforementioned circuitry may be instantiated by the example microprocessor 800 of FIG. 8 executing machine executable instructions such as those implemented by at least the blocks of FIGS. 4-6. In some examples, the aforementioned circuitry may be instantiated by hardware logic circuitry, which may be implemented by an ASIC, XPU, or the FPGA circuitry 900 of FIG. 9 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In operation, the example regression circuitry 204 determines whether to perform a model build operation(s) or a model evaluation operation(s). Generally speaking, examples disclosed herein facilitate an ability to generate and/or otherwise build models to calculate stock data (e.g., stock metrics, such as a quantity of a particular product available at a particular retailer during a particular period of time) based on available audit data. Example model building operations disclosed herein are a precursor to model evaluation operations to determine stock data corresponding to one or more retailer locations. In particular, while audit data corresponding to sales information is ubiquitous in a marketing environment, stock data is relatively scarce because audit personnel are less available. The lack of sufficient audit personnel is an effect of a relatively greater presence of on-site point of sale (PoS) systems at retailer locations that provide abundant and/or otherwise granular sales data to MREs, thereby reducing the original motivation for such audit personnel (e.g., to capture stock data so that sales data could be estimated therefrom). As discussed above, while sales data is readily available, clients still require and/or otherwise desire information corresponding to stock data, which is no longer abundant in view of the industry shift to PoS systems. In some examples, stock data facilitates opportunities for retailers and/or manufacturers to better understand their distribution (e.g., product shipping) behaviors. In some examples, the stock data facilitates control over distribution shipping orders from manufacturers to retailers. For instance, in the event the stock data indicates that stock values for a product of interest satisfy a threshold value, then examples disclosed herein cause one or more shipping orders to be increased or decreased.

In the event the example environment 200 is to perform model building operations, the example criteria evaluator circuitry 304 determines whether available audit data satisfies one or more time thresholds of availability. For example, modeling examples disclosed herein may require that a year's worth of audit data is available to satisfy one or more statistical quality requirements (e.g., a particular timespan of audit data is needed to achieve a satisfactory R-squared value for the model(s)). If not, then examples disclosed herein revert to traditional techniques to determine a relationship between sales data and stock data. On the other hand, if available audit data (e.g., ground truth data) satisfies the one or more timespan threshold requirements, then the example criteria evaluator circuitry 304 determines whether the audit data satisfies the one or more threshold metrics corresponding to quality (e.g., a recency (age) of collected audit (e.g., truth) data, a threshold quantity of retail stores, a threshold number of represented store groups (e.g., grocery stores) and/or a threshold number of product categories (e.g., shampoo)), then the example criteria evaluator circuitry 304 determines whether an independent variable of interest and a dependent variable of interest satisfy one or more correlation metrics. If so, then traditional techniques to determine a relationship between the abundant sales information and stock information may be employed.

On the other hand, when no such correlation exists, or when a greater degree of accuracy in determining any relationship between the sales data and the stock data is desired, examples disclosed herein apply a regression analysis that results in improved accuracy and lower computational expenditures due to, in part, reduced re-calculation efforts of traditional results that fail to meet industry standard R-squared values and/or correlation threshold expectations. As discussed above, in some examples regression analysis between an independent variable and a dependent variable may be attempted in which the dependent variable exhibits random effects despite other indications of coherent relationships therebetween (e.g., see FIG. 1 and a clear indication of some sort of relationship that does not properly regress as raw sales and stocks data points). While examples disclosed herein enable a unique manner of regression construction and analysis for any type of independent and dependent variable, use case examples disclosed herein will describe the independent variable in terms of sales data and the dependent variable in terms of stock data.

The example regression circuitry 204 begins model building operations by selecting one of the independent variable or the dependent variable. As discussed in further detail below, model building operations are substantially the same for the independent variable or the dependent variable, each of which is analyzed in turn to develop the model based on audit data. When complete, and as explained below, examples disclosed herein generate a model consistent with the illustrated example of Equation 4.

d_{stock i,j,p}=slope_{i,j}*d_{sales i,j,p} Equation 4.

In the illustrated example of Equation 4, i represents a particular store-group of interest, j represents a particular module or category of interest, and p represents a particular period of interest in which the regression is applied. As used herein, a store-group represents a type of store, such as a grocery store, a convenience store, a pharmacy, a hypermarket, etc. As used herein, a module or category of interest represents a group of product types, such as shampoo in which individual products within the category of shampoo can include different manufacturers, different sizes and/or any other characteristics of a shampoo product. Other categories may include, but are not limited to carbonated beverages, yogurt, beer, chips, pain killers, gum, etc.

Once the model is built (e.g., when the slope of Equation 4 has been determined), only PoS data (sales data) is needed to generate stock estimations (dependent variable) for retailers of interest. For the sake of example and not limitation, the example period average circuitry 306 calculates an aggregated average value of sales in a manner consistent with example Equation 5, sometimes referred to herein as calculating period averages or aggregated period averages.

$$\overline{sales} i , j , p = \frac{{\sum }_{s = 1}^{n} {sales}_{s , i , j , p}}{n} . \qquad Equation 5$$

In the illustrated example of Equation 5, the aggregated average value of sales is calculated for a particular store-group i, a particular product category j, a particular period p, and across all stores s of interest. In a similar manner, the example period average circuitry 306 calculates an aggregated average value of stock in a manner consistent with example Equation 6.

$$\overline{stock} i , j , p = \frac{{\sum }_{s = 1}^{n} {stock}_{s , i , j , p}}{n} . \qquad Equation 6$$

In some examples, the example regression circuitry 204 calculates ratios between the stock period average (s̅t̅o̅c̅k̅ i, j, p) and the sales period average (s̅a̅l̅e̅s̅ i, j, p) in a manner consistent with example Equation 7.

$${ratio}_{i , j , p} = \frac{\overline{stock} i , j , p}{\overline{sales} i , j , p} . \qquad Equation 7$$

As discussed in further detail below, the ratio may be compared against particular maximum and minimum values when applying the regression model to sales data. In particular, example minimum ratio values and example maximum ratio values may be calculated by the example regression circuitry 204 in a manner consistent with example Equations 8 and 9, respectively.

ratio_{i,j,min}=min(ratio_{i,j,p}) Equation 8.

ratio_{i,j,max}=max(ratio_{i,j,p}) Equation 9.

In addition to calculating period averages, as discussed above, examples disclosed herein also calculate overall averages in view of all periods of interest in which the regression model may be used. In particular, the example overall average circuitry 308 calculates an overall average sales value that is based on the aggregated period averages described above, and further in view of the particular store-group of interest, the particular product category of interest, and for all periods in a manner consistent with example Equation 10.

$$\overline{sales} i , j = \frac{{\sum }_{p = 1}^{k} \overline{sales} i , j , p}{k} . \qquad Equation 10$$

Similarly, the example overall average circuitry 308 calculates an overall average stock value that is based on the aggregated period averages described above, and further in view of the particular store-group of interest, the particular product category of interest, and for all periods in a manner consistent with example Equation 11.

$$\overline{stock} i , j = \frac{{Σ}_{p = 1}^{k} \overline{stock} i , j , p}{k} . \qquad Equation 11$$

In an effort to re-cap the previously calculated averages, note that the period averages corresponding to example Equations 5 and 6 exhibit a movement with respect to the overall averages corresponding to example Equations 10 and 11. Unlike merely attempting to regress and/or otherwise determine a linear relationship between sales and stock (which is not linear and can exhibit dependent variable random effects), examples disclosed herein consider the movement between period averages and overall averages. The movement between sales data and stock data exhibits a relationship that does not suffer from inconclusive results that occur from mere stock and sales values. Stated differently, examples disclosed herein analyze “differences of the differences” between average sales and stock data. In particular, the example movement analysis circuitry 310 calculates difference values for periods based on overall averages for all periods of interest in a manner consistent with example Equations 12 and 13.

d_{sales i,j,p}=s̅a̅l̅e̅s̅ i,j,p −sales i,j Equation 12.

d_{stock i,j,p}=s̅t̅o̅c̅k̅ i,j,p−s̅t̅o̅c̅k̅ i,j Equation 13.

In the illustrated examples of Equations 12 and 13, the difference in respective variables (e.g., the sales and the stock) corresponds to the previously calculated aggregated period averages and the previously calculated overall averages. These difference values form the basis of calculating and/or otherwise deriving a slope value for a regression model.

Prior to calculating the slope value, the example slope calculator circuitry 312 calculates intermediate variables in a manner consistent with example Equations 14-18. For ease of explanation, the following intermediate variables are assigned alphabetic designators “A,” “B,” “C,” “D,” and “E.”

$$A = {\sum }_{p = 1}^{k} {d}_{sales i , j , p} . \qquad Equation 14$$

$$B = {\sum }_{p = 1}^{k} {d}_{s tock i , j , p} . \qquad Equation 15$$

$$C = {\sum }_{p = 1}^{k} ( {d}_{sales i , j , p} * {d}_{s tock i , j , p} ) . \qquad Equation 16$$

$$D = {\sum }_{p = 1}^{k} {( {d}_{s ales i , j , p} )}^{2} . \qquad Equation 17$$

$$E = {( {\sum }_{p = 1}^{k} {d}_{sales i , j , p} )}^{2} . \qquad Equation 18$$

In the illustrated example of Equation 14, the slope calculator circuitry 312 calculates a sum of the average difference of sales for all periods. The example slope calculator circuitry 312 applies example Equations 14, 15 and 16 to the numerator of the regression model and, because stock information will be unavailable during evaluation of the model, example Equations 17 and 18 only incorporate sales data in the denominator of the regression model, as shown below in the illustrated example of Equation 19.

$${slope}_{i , j} = \frac{( k * C ) - ( A * B )}{( k * D ) - E} . \qquad Equation 19$$

Using the model of example Equation 19, the example slope calculator circuitry 312 determines stock values in a manner consistent with example Equation 20.

[symbol]

=slope_{i,j}*d_{sales i,j,p} Equation 20.

In some examples, assurances of model quality are required or otherwise preferred before employing examples disclosed herein to estimate stock values based on sales data. When such assurances are to be calculated, the example criteria evaluator circuitry 304 calculates an R-squared value in a manner consistent with example Equations 21, 22 and 23.

$$S {S}_{res i , j} = {\sum }_{p = 1}^{k} {( {d}_{s tock i , j , p} - )}^{2} . \qquad Equation 21$$

$$S {S}_{total i , j} = {\sum }_{p = 1}^{k} {( {d}_{stock i , j , p} - \overline{{d}_{stock l , J}} )}^{2} . \qquad Equation 22$$

$$R {2}_{i , j} = 1 - \frac{S {S}_{res i , j}}{S {S}_{total i , j}} . \qquad Equtaion 23$$

As described above, and in further detail below, the R-squared value of example Equation 23 permits an ability to determine a quality metric of the model. As such, one or more tests of the R-squared value may be considered as a threshold metric before the example model is applied to sales data in an effort to determine stock data.

After regression models are built, as described above, they may be used to estimate stock for stores where stock information is not available. As described above, the regression models may require assurances that they can be properly applied to a particular market of interest, which may depend on whether the geographic market of interest includes a threshold number of stores having historical data, as well as having an R-squared value that satisfies a particular threshold (e.g., larger than 0.1). In the event such qualifying information is not met, the aforementioned model should not be applied to the available historical data. In such circumstances, an alternate and/or otherwise traditional approach at attempting to quantify a relationship between stock and sales data can be applied in a manner consistent with example Equation 24.

$${Sales}_{ratio i , j} = \frac{{\sum }_{i , j , p , s} {stock}_{i , j , p , s}}{{\sum }_{i , j , p , s} {sales}_{i , j , p , s}} . \qquad Equation 24$$

As described above, the traditional approach at determining relationships between sales data and stock data in a manner consistent with example Equation 24 may result in erroneous results that require computational re-modeling (energy consumption/waste), re-evaluation, weight and/or parameter adjustments in an effort to derive stock estimations that reflect consistency with ground truth data. Additionally, despite efforts to re-model, re-evaluate and/or otherwise apply correction weighting factors in an effort to determine results that mirror ground truth expectations, such efforts may ultimately remain unsuccessful.

In the event examples disclosed herein are to be applied (e.g., because indications of model quality satisfy one or more R-squared thresholds), the example period average circuitry 306 calculates period averages in a manner similar to that discussed above in connection with example Equation 5. However, now that only sales data is being utilized in the effort to identify corresponding stock data, the example period average circuitry 306 determines the period average in a manner consistent with example Equation 25.

$$\overline{{sales}_{l , J , {est}_{p}} = \frac{{\sum }_{s = 1}^{n} {sales}_{s , l , J , {est}_{p}}}{n}} . \qquad Equation 25$$

In the illustrated example of Equation 25, estₚ corresponds to a specific period for which stock estimation information is desired (and the specific period corresponding to the historical sales data to which the regression model is being applied).

The example movement analysis circuitry 310 calculates a period movement using the overall average sales value that was calculated above in connection with example Equation 10. In particular, this result is applied to calculate the period movement in a manner consistent with example Equation 26.

d_{sales i,j,est}_{ₚ}=s̅a̅l̅e̅s̅_{i,j,est}_{ₚ}=s̅a̅l̅e̅s̅_{i,j} Equation 26.

As described above, estₚ corresponds to a specific period for which stock estimation information is desired (and the specific period corresponding to the historical sales data to which the regression model is being applied), and the difference in sales is based on the aggregated average value of sales corresponding to the period of interest (s̅a̅l̅e̅s̅_{i,j,est}_{ₚ}) and the overall average sales value for all periods (s̅a̅l̅e̅s̅_{i,j}). The example model evaluation circuitry 314 then applies the model to the difference in sales (e.g., the movement in sales) to determine a stock difference value in a manner consistent with example Equation 27.

d_{stock i,j,est}_{ₚ}=slope_{i,j}*d_{sales i,j,est}_{ₚ} Equation 27.

From the difference value of example Equation 27, the example model evaluation circuitry 314 calculates an estimated average stock for the estimation period of interest in a manner consistent with example Equation 28.

e̅s̅t̅S̅t̅o̅c̅k̅_{i,j,est}_{ₚ}=d_{stock i,j,est}_{ₚ}+s̅t̅o̅c̅k̅_{i,j} Equation 28.

In the example of Equation 28, the estimated stock is based on the difference value corresponding to the model slope offset by the overall average stock value for all periods of interest, as was calculated in a manner consistent with example Equation 11 above.

As discussed above, the example regression circuitry 204 determined and/or otherwise calculated ratios based on available audit data, in which the ratios correspond to stock period averages and sales period averages (see example Equation 7). Additionally, this ratio forms the basis of determining whether applied sales data during evaluation is suitable for the model and accuracy expectations for that model in view of applied sales data. As such, the example regression circuitry 204 determined corresponding minimum and maximum ratio values to serve as indicators of whether applied sales data works well with the model (see example Equations 8 and 9). However, now that the model has been generated and sales data has been applied to estimate stock data, as shown in a manner consistent with example Equation 28, the example regression circuitry 204 again calculates a ratio to make sure it does not fall outside the boundaries of the previously established minimum and maximum values. In particular, the regression circuitry 204 calculates an estimated ratio in a manner consistent with example Equation 29.

$${ratio}_{i , j , e s {t}_{p}} = \frac{{\overline{est stock}}_{i , j , es {t}_{p}}}{{\overline{sales}}_{i , j , e s {t}_{p}}} . \qquad Equation 29$$

If the resulting ratio from the estimated stock is less than the previously calculated minimum ratio value (see example Equation 8) or greater than the previously calculated maximum ratio value (see example Equation 9), then the estimated stock value (see example Equation 28) is recalculated using a min/max ratio in a manner consistent with example Equations 30 and 31.

If ratio_{i,j,est}_{ₚ}<ratio_{i,j,min}

Then

e̅s̅t̅ S̅t̅o̅c̅k̅_{i,j,est}_{ₚ}=ratio_{i,j,min}*s̅a̅l̅e̅s̅_{i,j,est}_{ₚ} Equation 30.

Else If ratio_{i,j,est}_{ₚ}>ratio_{i,j,max}

Then

e̅s̅t̅S̅t̅o̅c̅k̅_{i,j,est}_{ₚ}=ratio_{i,j,max}*s̅a̅l̅e̅s̅_{i,j,est}_{ₚ} Equation 31.

Using the estimated stock value from either Equation 30 or 31, depending on which gets triggered, then individual store stock values may be calculated in a manner consistent with example Equation 32.

$$est {Stock}_{i , j , {est}_{p} , s} = {\overline{est Stock}}_{i , j , e s {t}_{p}} * \frac{{sales}_{i , j , {est}_{p} , s}}{{\overline{sales}}_{i , j , es {t}_{p}}} . \qquad Equation 32$$

In the illustrated example of Equation 32, sales_{i,j,est}_{ₚ}ₛ corresponds to sales of each individual store for a respective category (module) during the estimation period of interest.

As described above, examples disclosed herein facilitate the ability to control distribution behaviors based on whether estimated stock values satisfy one or more thresholds. In some examples, the model evaluation circuitry 314 evaluates the estimated stock values against a threshold value. Some products may have a particular shipping lead time that is longer than other products. In other words, a degree of responsivity to a shipment request is faster for some products than others such that a store shelf is less likely to experience a shortage of product availability when an order is placed. On the other hand, some products are associated with an expected (e.g., an average) shipping lead time that is relatively longer, meaning that the particular product could be out of stock while waiting for the shipment to arrive. Based on particular expectations of shipping lead times for products of interest, the example model evaluation circuitry 314 tests and/or otherwise evaluates the estimated stock value against a threshold stock value. In circumstances where the estimated stock value is relatively low and the expected lead time of the shipping is relatively high, then the model evaluation circuitry 314 causes a corresponding shipping order to occur. As such, additional stock corresponding to that product is more likely to arrive before an out of stock situation occurs. Generally speaking, the model evaluation circuitry 314 enables shipping orders to be augmented based on the output of the regression model, which can cause some particular shipments to occur (based on threshold tests), or cause other particular shipments to be delayed (e.g., when deliveries for that product are relatively fast). In some examples, delaying the shipment request for readily available products allows retailers to receive needed restocking when needed, and avoids concern regarding where to store excess stock (e.g., avoids a need for warehouse storage).

While an example manner of implementing the regression circuitry 204 of FIG. 2 is illustrated in FIG. 3, one or more of the elements, processes, and/or devices illustrated in FIGS. 2 and/or 3 may be combined, divided, re-arranged, omitted, eliminated, and/or implemented in any other way. Further, the example model build circuitry 302, the example model evaluation circuitry 314, the example criteria evaluator circuitry 304, the example period average circuitry 306, the example overall average circuitry 308, the example movement analysis circuitry 310, the example slope calculator circuitry 312 and/or, more generally, the example regression circuitry 204 of FIG. 3, may be implemented by hardware alone or by hardware in combination with software and/or firmware. Thus, for example, any of the example model build circuitry 302, the example model evaluation circuitry 314, the example criteria evaluator circuitry 304, the example period average circuitry 306, the example overall average circuitry 308, the example movement analysis circuitry 310, the example slope calculator circuitry 312 and/or, more generally, the example regression circuitry 204 of FIG. 3, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example regression circuitry 204 of FIGS. 2 and 3 may include one or more elements, processes, and/or devices in addition to, or instead of, those illustrated in FIG. 3, and/or may include more than one of any or all of the illustrated elements, processes and devices.

Flowcharts representative of example machine readable instructions, which may be executed to configure processor circuitry to implement the regression circuitry 204 of FIGS. 2 and 3, are shown in FIGS. 4-6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4-6, many other methods of implementing the example regression circuitry 204 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to regress independent and dependent data that, in its initial format, exhibits non-correlative effects. The machine readable instructions and/or the operations 400 of FIG. 4 begin at block 402, at which the example regression circuitry 204 determines whether to perform model building operations or model evaluation operations. For example, in the event a first attempt is made by an MRE 202 to regress independent and dependent data in its initial and/or otherwise raw format (e.g., sales data and stock data), results may be erroneous and the dependent data may exhibit random effects that cannot be correlated in view of industry and/or statistical expectations. As discussed above, despite this anomalous statistical effect when attempting to regress, plots of time-series and/or historical data may indicate that there is a type of relationship that exists between the independent and dependent variables (see FIG. 1). Accordingly, examples disclosed herein prepare the initial (first) format independent and dependent data into a subsequent (second) format that, when applied to a regression model, does not suffer the same anomalous statistical effects. To accomplish the development, construction, and/or otherwise building of an improved model, the example regression circuitry 204 instantiates the model build circuitry 302 to build a regression model based on the initial variable data (block 404) (e.g., available audit data). On the other hand, in the event a prior model construction/build has occurred in view of the initial independent and dependent variable data, then the example regression circuitry 204 instantiates the example model evaluation circuitry 314 to evaluate a regression based on the previously build model (block 406) using only sales data.

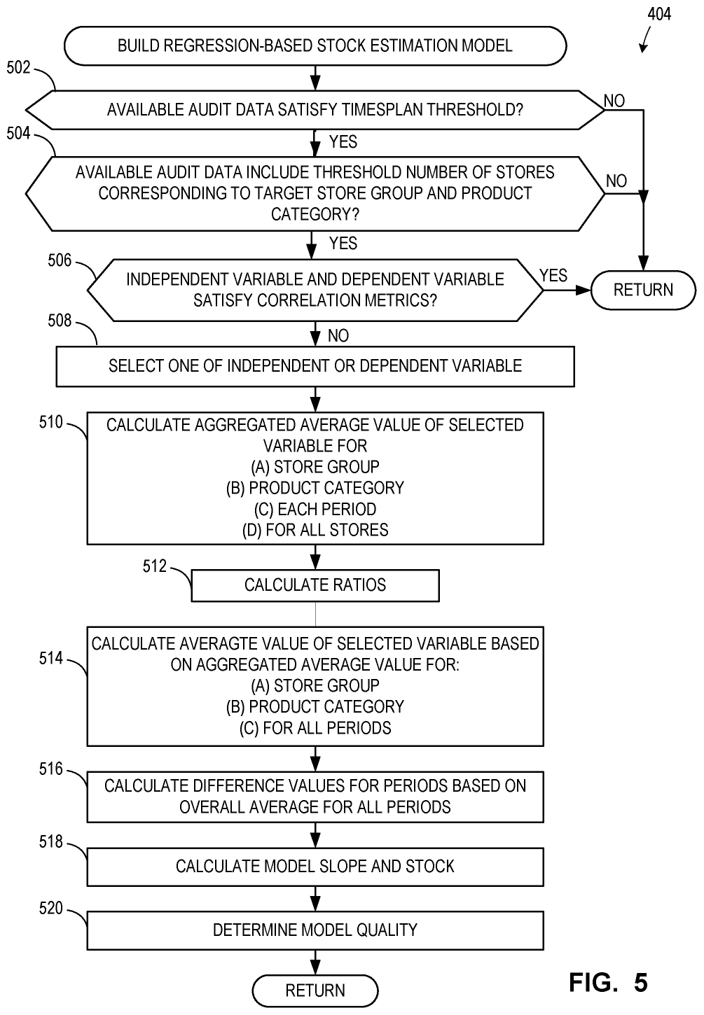

FIG. 5 illustrates additional detail corresponding to building a regression-based stock estimation model (block 404). In the illustrated example of FIG. 5, the example criteria evaluator circuitry 304 determines whether available audit data satisfies a timespan threshold (block 502). As discussed above, examples disclosed herein apply when particular audit data requirements are satisfied so that one or more statistical results of examples disclosed herein meet expectations that match ground truth expectations. In the event the criteria evaluator circuitry 304 determines that there are not sufficient data to satisfy timespan thresholds (e.g., less than 52-weeks of available audit data), then the example process 404 of FIG. 5 returns to block 402 of FIG. 4.

On the other hand, when the example criteria evaluator circuitry 304 determines that there is sufficient data to satisfy timespan thresholds (block 502), then the example criteria evaluator circuitry 304 determines if the available audit data includes a threshold number of stores corresponding to a target store group and product category (block 504). If not, then the example process 404 of FIG. 5 returns to block 402 of FIG. 4, otherwise the example criteria evaluator circuitry 304 determines whether the independent variable and the dependent variables of interest (e.g., sales data and stock data, respectively) satisfy correlation metrics (block 506). If not, then the example process 404 of FIG. 5 returns to block 402 of FIG. 4. As described above, in some examples input data (e.g., independent and dependent variable data) does not exhibit correlation metrics that facilitate regression output that can be considered valuable, relevant and/or otherwise compliant with ground truth expectations. In the event correlation metrics are satisfied, meaning that traditional correlation techniques are likely to work (block 506), then the example process 404 of FIG. 5 returns to block 402 of FIG. 4.

However, when the example criteria evaluator circuitry 304 determines that correlation metrics are not satisfied (block 506), meaning that application of traditional regression techniques will fail, the example regression circuitry 204 selects one of the independent variable of interest (e.g., sales) or the dependent variable of interest (e.g., stock) (block 508). As described above, each of the independent variable and the dependent variable (and data associated therewith) are transformed in a manner that corrects unwanted effects of dependent variable non-correlation. In particular, the example period average circuitry 306 calculates aggregated average values of the selected variable (e.g., sometimes referred to herein as “period averages”) (e.g., for either sales or stock) based on (a) a store group of interest, (b) a product category of interest, (c) a period of interest and (d) all stores in which the regression is to apply (block 510). As described in further detail below, the period average circuitry 306 calculates the period averages in a manner consistent with example Equation 5 (if the sales variable data is selected) and example Equation 6 (if the stock variable data is selected). The example regression circuitry 204 calculates ratios (e.g., in a manner consistent with example Equation 7) between the period averages (block 512), which are used to establish minimum and maximum values (e.g., in a manner consistent with example Equations 8 and 9) with which the regression model can be applied.

The example overall average circuitry 308 calculates overall averages (block 514). In particular, and as described above, the overall average circuitry 308 calculates average values of the independent and dependent variables based on (a) the period averages above and (b) the store group of interest, (c) the product category of interest and (d) all periods in which the regression model is to be applied (block 514). As described above, period averages exhibit a movement with respect to the overall averages corresponding to the aggregation of all periods, and it is this movement that allows a relationship between the sales data and the stock data to be regressed in a manner that avoids random effects. The example movement analysis circuitry 310 calculates difference values for periods based on the overall averages for all periods of interest (block 516). Stated differently, the movement analysis circuitry 310 calculates movements between individual periods and overall periods in a manner consistent with example Equation 12 (e.g., for sales data) and example Equation 13 (e.g., for stock data).

The example slope calculator circuitry 312 calculates a model stope (block 518) that is used when evaluating stock data when the only available input data is sales data. In an abundance of caution, the example criteria evaluator circuitry 304 determines a model quality (block 520), such as determining an R-squared value (e.g., in a manner consistent with example Equations 21-23). Control then returns to block 402 of FIG. 4.

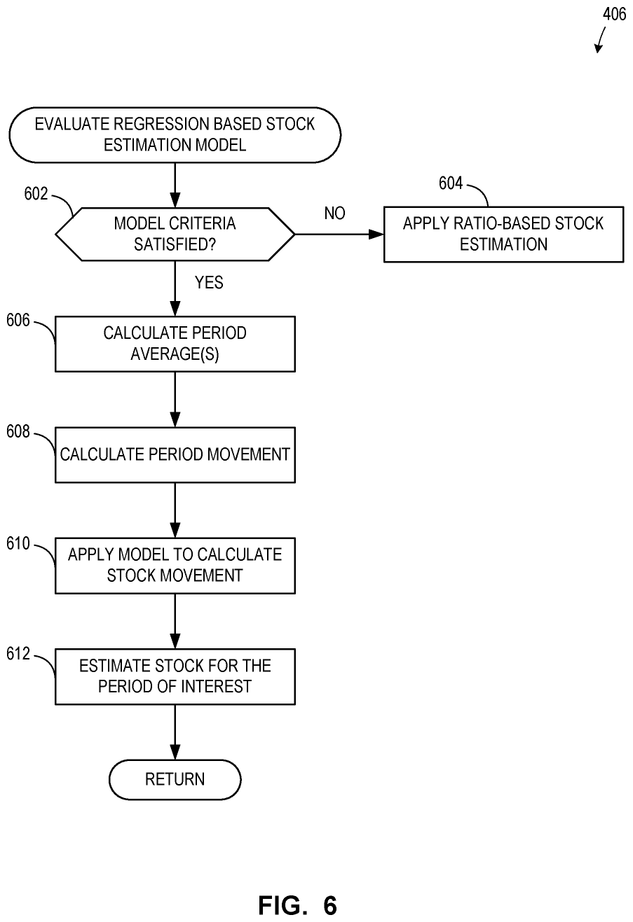

FIG. 6 illustrates additional detail corresponding to evaluating the regression-based stock estimation model (block 406) of FIG. 4. In the illustrated example of FIG. 6, the criteria evaluator circuitry 304 verifies that one or more criterion are satisfied (block 602) that serve as indicators that application of the model will be successful in view of applied independent data (e.g., sales data from PoS systems). In the event the criteria are not satisfied (block 602), then the example regression circuitry 204 applies alternate techniques in an effort to find a relationship between the independent and dependent variables (e.g., sales and stock data) (block 604), and control returns to block 402 of FIG. 4. However, if the criteria are satisfied (block 602), then the example period average circuitry 306 calculates period averages in a manner similar to that described in connection with example Equations 5 and 6 (block 606), and the example movement analysis circuitry 310 calculates period movements (block 608). The example model evaluation circuitry 314 applies the model to calculate stock movement data (block 610) and estimates stock values for the period of interest (block 612).

FIG. 7 is a block diagram of an example processor platform 700 structured to execute and/or instantiate the machine readable instructions and/or the operations of FIGS. 4-6 to implement the regression circuitry 204 of FIGS. 2 and 3. The processor platform 700 can be, for example, a server, a personal computer, a workstation, a self-learning machine (e.g., a neural network), a mobile device (e.g., a cell phone, a smart phone, a tablet such as an iPad™, an Internet appliance, a gaming console, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example model build circuitry 302, the example model evaluation circuitry 314, the example criteria evaluator circuitry 304, the example period average circuitry 306, the example overall average circuitry 308, the example movement analysis circuitry 310, the example slope calculator circuitry 312 and/or, more generally, the example regression circuitry 204 of FIG. 3.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 420. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 732, which may be implemented by the machine readable instructions of FIGS. 4-6, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowcharts of FIGS. 4-6 to effectively instantiate the circuitry of FIGS. 2 and 3 as logic circuits to perform the operations corresponding to those machine readable instructions. In some such examples, the circuitry of FIGS. 2 and 3 is instantiated by the hardware circuits of the microprocessor 800 in combination with the instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 4-6 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 4-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 4-6. As such, the FPGA circuitry 900 may be structured to effectively instantiate some or all of the machine readable instructions of the flowcharts of FIGS. 4-6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIGS. 4-6 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may be implemented by external hardware circuitry. For example, the external hardware 906 may be implemented by the microprocessor 800 of FIG. 8. The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations that may correspond to at least some of the machine readable instructions of FIGS. 4-6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 4-6 may be executed by one or more of the cores 802 of FIG. 8, a second portion of the machine readable instructions represented by the flowcharts of FIGS. 4-6 may be executed by the FPGA circuitry 900 of FIG. 9, and/or a third portion of the machine readable instructions represented by the flowcharts of FIGS. 4-6 may be executed by an ASIC. It should be understood that some or all of the circuitry of FIGS. 2 and/or 3 may, thus, be instantiated at the same or different times. Some or all of the circuitry may be instantiated, for example, in one or more threads executing concurrently and/or in series. Moreover, in some examples, some or all of the circuitry of FIGS. 2 and/or 3 may be implemented within one or more virtual machines and/or containers executing on the microprocessor.

In some examples, the processor circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

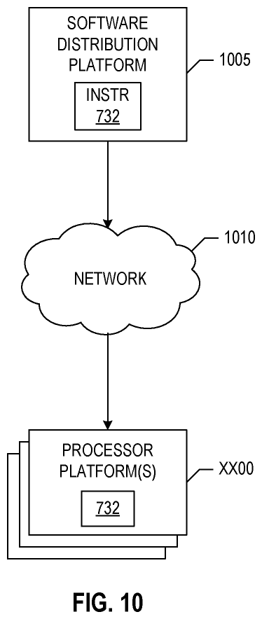

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIGS. 4-6, may be downloaded to the example processor platform 700, which is to execute the machine readable instructions 732 to implement the example regression circuitry 204. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that improve computational efficiency of regression tools and/or computational devices by avoiding and/or otherwise overcoming failed regression attempts due to particular input data exhibiting non-correlation effects. When such non-correlation effects typically occur, re-calculation efforts are applied in an effort to derive one or more correction sub models in an effort to generate a disparate set of models that attempt to track expectations of ground truth data. As such, computational waste occurs when such efforts fail and/or otherwise do not meet standards deemed statistically valid.

Example methods, apparatus, systems, and articles of manufacture to regress independent and dependent variable data are disclosed herein. Further examples and combinations thereof include the following:

Example 1 includes an apparatus to generate movement values for a regression model, comprising at least one memory, machine readable instructions, and processor circuitry to at least one of instantiate or execute the machine readable instructions to calculate period average sales values for ones of stores associated with (a) a store group of interest, (b) a category of interest and (c) ones of periods of interest, the period average sales values based on a number of the ones of the stores, calculate period average stock values for the ones of the stores associated with (a) the store group of interest, (b) the category of interest and (c) the ones of the periods of interest, the period average stock values based on the number of ones of the stores, calculate overall average sales values based on the period average sales values corresponding to all of the ones of the periods of interest, calculate overall average stock values based on the period average stock values corresponding to all of the ones of the periods of interest, and prevent random effects corresponding to stock input data used in the regression model by calculating sales movement values based on a difference between the period average sales values and the overall sales values, and calculating stock movement values based on a difference between the period average stock values and the overall average stock values.

Example 2 includes the apparatus as defined in example 1, wherein the processor circuitry is to calculate a slope for the regression model based on a ratio of (a) sums of average differences of the sales movement values and sums of average differences of the stock movement values and (b) sums of squared values of the sales movement values.

Example 3 includes the apparatus as defined in example 2, wherein the slope is based on all of the ones of the periods of interest corresponding to the stock input data and sales input data.

Example 4 includes the apparatus as defined in example 1, wherein the period average sales values correspond to an independent variable of the regression model.

Example 5 includes the apparatus as defined in example 1, wherein the period average stock values correspond to a dependent variable of the regression model.

Example 6 includes the apparatus as defined in example 1, wherein the processor circuitry is to cause a shipping order to be augmented based on an output of the regression model.

Example 7 includes the apparatus as defined in example 6, wherein the processor circuitry is to at least one of (a) cause the shipping order to increase a quantity of product shipped to the number of the ones of the stores or (b) cause the shipping order to decrease a quantity of the product shipped to the number of the ones of the stores.

Example 8 includes an apparatus to determine movement values, comprising period average circuitry to calculate period average sales values for ones of stores associated with (a) a store group of interest, (b) a category of interest and (c) ones of periods of interest, the period average sales values based on a number of the ones of the stores, and calculate period average stock values for the ones of the stores associated with (a) the store group of interest, (b) the category of interest and (c) the ones of the periods of interest, the period average stock values based on the number of ones of the stores, overall average circuitry to calculate overall average sales values based on the period average sales values corresponding to all of the ones of the periods of interest, and calculate overall average stock values based on the period average stock values corresponding to all of the ones of the periods of interest, and movement analysis circuitry to prevent random effects corresponding to stock input data used in a regression model by calculating sales movement values based on a difference between the period average sales values and the overall sales values, and calculating stock movement values based on a difference between the period average stock values and the overall average stock values.

Example 9 includes the apparatus as defined in example 8, further including slope calculator circuitry to calculate a slope for the regression model based on a ratio of (a) sums of average differences of the sales movement values and sums of average differences of the stock movement values and (b) sums of squared values of the sales movement values.

Example 10 includes the apparatus as defined in example 9, wherein the slope calculator circuitry is to determine the slope based on all of the ones of the periods of interest corresponding to the stock input data and sales input data.

Example 11 includes the apparatus as defined in example 8, wherein the period average circuitry is to determine the period average sales values based on an independent variable of the regression model.

Example 12 includes the apparatus as defined in example 8, wherein the period average circuitry is to determine the period average stock values based on a dependent variable of the regression model.

Example 13 includes the apparatus as defined in example 8, further including model evaluation circuitry to augment a shipping order based on an output of the regression model.

Example 14 includes the apparatus as defined in example 13, wherein the model evaluation circuitry is to at least one of (a) cause the shipping order to increase a quantity of product shipped to the number of the ones of the stores or (b) cause the shipping order to decrease a quantity of the product shipped to the number of the ones of the stores.

Example 15 includes a non-transitory machine readable storage medium comprising instructions that, when executed, cause processor circuitry to at least calculate period average sales values for ones of stores associated with (a) a store group of interest, (b) a category of interest and (c) ones of periods of interest, the period average sales values based on a number of the ones of the stores, calculate period average stock values for the ones of the stores associated with (a) the store group of interest, (b) the category of interest and (c) the ones of the periods of interest, the period average stock values based on the number of ones of the stores, calculate overall average sales values based on the period average sales values corresponding to all of the ones of the periods of interest, calculate overall average stock values based on the period average stock values corresponding to all of the ones of the periods of interest, and prevent random effects corresponding to stock input data used in the regression model by calculating sales movement values based on a difference between the period average sales values and the overall sales values, and calculating stock movement values based on a difference between the period average stock values and the overall average stock values.

Example 16 includes the non-transitory machine readable storage medium as defined in example 15, wherein the instructions, when executed, cause the processor circuitry to calculate a slope for the regression model based on a ratio of (a) sums of average differences of the sales movement values and sums of average differences of the stock movement values and (b) sums of squared values of the sales movement values.

Example 17 includes the non-transitory machine readable storage medium as defined in example 16, wherein the instructions, when executed, cause the processor circuitry to calculate the slope based on all of the ones of the periods of interest corresponding to the stock input data and sales input data.

Example 18 includes the non-transitory machine readable storage medium as defined in example 15, wherein the instructions, when executed, cause the processor circuitry to calculate the period average sales values based on an independent variable of the regression model.

Example 19 includes the non-transitory machine readable storage medium as defined in example 15, wherein the instructions, when executed, cause the processor circuitry to calculate the period average stock values based on a dependent variable of the regression model.

Example 20 includes the non-transitory machine readable storage medium as defined in example 15, wherein the instructions, when executed, cause the processor circuitry to change a shipping order based on an output of the regression model.

Example 21 includes the non-transitory machine readable storage medium as defined in example 20, wherein the instructions, when executed, cause the processor circuitry to at least one of (a) cause the shipping order to increase a quantity of product shipped to the number of the ones of the stores or (b) cause the shipping order to decrease a quantity of the product shipped to the number of the ones of the stores.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus to generate movement values for a regression model, comprising:
at least one memory;
machine readable instructions; and
processor circuitry to at least one of instantiate or execute the machine readable instructions to:
calculate period average sales values for ones of stores associated with (a) a store group of interest, (b) a category of interest and (c) ones of periods of interest, the period average sales values based on a number of the ones of the stores;
calculate period average stock values for the ones of the stores associated with (a) the store group of interest, (b) the category of interest and (c) the ones of the periods of interest, the period average stock values based on the number of ones of the stores;
calculate overall average sales values based on the period average sales values corresponding to all of the ones of the periods of interest;
calculate overall average stock values based on the period average stock values corresponding to all of the ones of the periods of interest; and
prevent random effects corresponding to stock input data used in the regression model by:
calculating sales movement values based on a difference between the period average sales values and the overall sales values; and
calculating stock movement values based on a difference between the period average stock values and the overall average stock values.

2. The apparatus as defined in claim 1, wherein the processor circuitry is to calculate a slope for the regression model based on a ratio of (a) sums of average differences of the sales movement values and sums of average differences of the stock movement values and (b) sums of squared values of the sales movement values.

3. The apparatus as defined in claim 2, wherein the slope is based on all of the ones of the periods of interest corresponding to the stock input data and sales input data.

4. The apparatus as defined in claim 1, wherein the period average sales values correspond to an independent variable of the regression model.

5. The apparatus as defined in claim 1, wherein the period average stock values correspond to a dependent variable of the regression model.

6. The apparatus as defined in claim 1, wherein the processor circuitry is to cause a shipping order to be augmented based on an output of the regression model.

7. The apparatus as defined in claim 6, wherein the processor circuitry is to at least one of (a) cause the shipping order to increase a quantity of product shipped to the number of the ones of the stores or (b) cause the shipping order to decrease a quantity of the product shipped to the number of the ones of the stores.

8. An apparatus to determine movement values, comprising:
period average circuitry to:
calculate period average sales values for ones of stores associated with (a) a store group of interest, (b) a category of interest and (c) ones of periods of interest, the period average sales values based on a number of the ones of the stores; and
calculate period average stock values for the ones of the stores associated with (a) the store group of interest, (b) the category of interest and (c) the ones of the periods of interest, the period average stock values based on the number of ones of the stores;
overall average circuitry to:
calculate overall average sales values based on the period average sales values corresponding to all of the ones of the periods of interest; and
calculate overall average stock values based on the period average stock values corresponding to all of the ones of the periods of interest; and
movement analysis circuitry to prevent random effects corresponding to stock input data used in a regression model by:
calculating sales movement values based on a difference between the period average sales values and the overall sales values; and
calculating stock movement values based on a difference between the period average stock values and the overall average stock values.

9. The apparatus as defined in claim 8, further including slope calculator circuitry to calculate a slope for the regression model based on a ratio of (a) sums of average differences of the sales movement values and sums of average differences of the stock movement values and (b) sums of squared values of the sales movement values.

10. The apparatus as defined in claim 9, wherein the slope calculator circuitry is to determine the slope based on all of the ones of the periods of interest corresponding to the stock input data and sales input data.

11. The apparatus as defined in claim 8, wherein the period average circuitry is to determine the period average sales values based on an independent variable of the regression model.

12. The apparatus as defined in claim 8, wherein the period average circuitry is to determine the period average stock values based on a dependent variable of the regression model.

13. The apparatus as defined in claim 8, further including model evaluation circuitry to augment a shipping order based on an output of the regression model.

14. The apparatus as defined in claim 13, wherein the model evaluation circuitry is to at least one of (a) cause the shipping order to increase a quantity of product shipped to the number of the ones of the stores or (b) cause the shipping order to decrease a quantity of the product shipped to the number of the ones of the stores.

15. A non-transitory machine readable storage medium comprising instructions that, when executed, cause processor circuitry to at least:
calculate period average sales values for ones of stores associated with (a) a store group of interest, (b) a category of interest and (c) ones of periods of interest, the period average sales values based on a number of the ones of the stores;
calculate period average stock values for the ones of the stores associated with (a) the store group of interest, (b) the category of interest and (c) the ones of the periods of interest, the period average stock values based on the number of ones of the stores;
calculate overall average sales values based on the period average sales values corresponding to all of the ones of the periods of interest;
calculate overall average stock values based on the period average stock values corresponding to all of the ones of the periods of interest; and
prevent random effects corresponding to stock input data used in the regression model by:
calculating sales movement values based on a difference between the period average sales values and the overall sales values; and
calculating stock movement values based on a difference between the period average stock values and the overall average stock values.

16. The non-transitory machine readable storage medium as defined in claim 15, wherein the instructions, when executed, cause the processor circuitry to calculate a slope for the regression model based on a ratio of (a) sums of average differences of the sales movement values and sums of average differences of the stock movement values and (b) sums of squared values of the sales movement values.

17. The non-transitory machine readable storage medium as defined in claim 16, wherein the instructions, when executed, cause the processor circuitry to calculate the slope based on all of the ones of the periods of interest corresponding to the stock input data and sales input data.

18. The non-transitory machine readable storage medium as defined in claim 15, wherein the instructions, when executed, cause the processor circuitry to calculate the period average sales values based on an independent variable of the regression model.

19. The non-transitory machine readable storage medium as defined in claim 15, wherein the instructions, when executed, cause the processor circuitry to calculate the period average stock values based on a dependent variable of the regression model.

20. The non-transitory machine readable storage medium as defined in claim 15, wherein the instructions, when executed, cause the processor circuitry to change a shipping order based on an output of the regression model.

21. The non-transitory machine readable storage medium as defined in claim 20, wherein the instructions, when executed, cause the processor circuitry to at least one of (a) cause the shipping order to increase a quantity of product shipped to the number of the ones of the stores or (b) cause the shipping order to decrease a quantity of the product shipped to the number of the ones of the stores.
